(19) United States
(12) Patent Application Publication
(10) Pub. No.: US 2019/0254413 A1
(43) Pub. Date: Aug. 22, 2019

(54) Toothbrush Tracking Apparatus and Method

(71) Applicant: Dov Jacobson, Berkeley Lakes, GA (US)

(72) Inventor: Dov Jacobson, Berkeley Lakes, GA (US)

(21) Appl. No.: 15/900,782

(22) Filed: Feb. 20, 2018

(51) Int. Cl. A46B 15/00; G06T 7/20; G06T 7/70; H04W 4/80

(52) U.S. Cl. CPC A46B 15/0006; A46B 15/0085; A46B 2200/1066; G06T 7/70; H04W 4/80; G06T 7/20

(57) ABSTRACT

The present invention is a system that comprises a toothbrush with fiducial markers (a fiduciated toothbrush), a sensor and a computation engine. The system tracks the position, orientation and motion of the fiduciated brush relative to the sensor or relative to another object within view of the sensor, Several marker systems offer elevated fiducial salience above the salience of other objects in the scene. These systems include retroreflective markers illuminated by a light source near the sensor, or light emitting markers, or fluorescent markers illuminated by ultraviolet light. In every case the illumination can be modulated to create from each fiducial marker a set of temporal fiducials that allow for intra-frame motion analysis. Non-uniform temporal modulation patterns as well a differently colored markers help disambiguate the sensor data.

### CROSS-REFERENCE TO RELATED APPLICATIONS

Based on Provisional Patent 62/460,992

Toothbrush Tracking Apparatus and Method

Jacobson Feb. 20, 2017

### STATEMENT REGARDING FEDERALLY SPONSORED RESEARCH OR DEVELOPMENT

Not Applicable

### REFERENCE TO SEQUENCE LISTING A TABLE, OR A COMPUTER PROGRAM LISTING COMPACT DISC APPENDIX

Not Applicable

### BACKGROUND OF THE INVENTION

### Technical Field

382 Image Analysis 103 Target tracking or detecting

### Technical Problem

Dental caries is arguably the most widespread infectious disease currently plaguing the industrialized world. Its global burden can be lightened by conscientious individual oral hygiene. Toothbrushing habits are formed early in life, so it is essential that children develop good brushing technique and habits. Few caregivers have the skills, time and patience to properly train toothbrush mastery.

Technology can help. It has been shown that interactive digital games can effectively train children to brush their teeth. Manual skill training is optimized by accurate iterative assessment of the learner's performance. In the case of toothbrush training, interactive training typically depends on a sensor system that reports the child's actual toothbrush activity.

### BACKGROUND ART

Early attempts at electronic enhancement of the toothbrush to promote training were not interactive and did not track the brush motions. Devices by Dickie (2008) nd Mottram (2008) merely signal the brusher that it is time to move to the next sector of the mouth. These are updated versions of the system taught by Arnauld (1986), All of these are timers not trainers, and all lack any sort of interactivity.

Primitive interactivity was introduced by Kwok (1992), who utilized a primitive motion switch to detect activity. This is sensitive enough to estimate raw compliance with a brushing schedule but not to assess brushing performance.

A different approach was taken by Korean and German inventors Kim (2015) and Dienzer (2014) who each propose to put cameras and lights in the toothbrush and use machine vision to assess brushing based on this view of teeth. This system depends on great uniformity in the appearance of the teeth. Machine learning has limits, and even if these systems can accurately detect brushing defects, they will find it difficult to classify the errors and communicate a corrective instruction to the learners.

A prior technology solution is the instrumented toothbrush, as taught by Jacobson (2008). Said toothbrush contains accelerometers and gyroscopes for inertial motion tracking, as well as a means to report data from these sensors to the computation platform. While it can accurate report relative motion and certain axes of orientation, the Instrumented toothbrush has electronic content that establishes an irreducible cost. This cost limits the adoption rate of the instrumented toothbrush and any training software that depends on it.

Even were it were not expensive, the instrumented toothbrush would not satisfy the requirements of toothbrush performance assessment because its inertial. measurement unit (IMU) reports only relative motion unrelated to the child's frame of reference.

Chang teaches the use of a cube-shaped extension to the toothbrush that has distinct pattern of light on each of four faces. An overhead camera reads the pattern to measure the long-axis rotation (roll) o the brush as well locating it on a horizontal plane. While an interesting pioneering effort, the system was impractical. It required a large rig with multiple cameras and only returned 4 degrees of freedom (x,y, roll and yaw)

Finally Alarcon and Saurubbo 2015 propose a notionally spherical marker mounted on the far end of the toothbrush. The sphere is divided into octants or finer divisions, with each featuring a distinct color. The camera, from its point of view, can analyze the color resulting from segments exposed to it and calculates the relative orientation of the toothbrush. Naturally this method is susceptible to variations in ambient lighting. It also has no accurate means to measure distance from the camera. It cannot determine the speed with which the brush moves toward and away from the camera. Therefore, assuming the child is facing toward the game, for most of the mouth the Maim system the Macron system mouth, it cannot answer critical questions like how hard is the child scrubbing, while looking at the game.

### BRIEF SUMMARY OF INVENTION

### Solution to Problem

Rather than an instrumented toothbrush, the present invention relies only on digital resources already present in the game device, notionally a smartphone, tablet or laptop. These resources comprise sensors, computation hardware and audio visual displays. The toothbrush presents fiducial markers to the tablet's camera in order to report its position, rather than aggregating, processing and transmitting data from onboard digital components. This toothbrush, bearing fiducial markers, is hereafter called the fiduciated toothbrush.

### Advantageous Effects of Invention

The current invention offers several advantages over existing solutions,

The present invention enjoys an irreducible cost advantage: Because it has a far more modest Bill of Materials, the fiduciated toothbrush will always be far less expensive than the instrumented toothbrush. AH other hardware requirements are met by the components in a smartphone, tablet or computer already in the possession of the player. Even while the price of instrumentation decreases, the fiduciated toothbrush can be expected to be an order of magnitude less expensive. Passive fiducial markers add very little to the cost of toothbrush manufacture. Active markers raise the cost, but this higher cost is still negligible compared to that of an instrumented brush.

The present invention delivers position data A system based on inertial sensors can accurately measure changes in velocity (using its three orthogonal accelerometers) and it can measure torque (using the gyroscopes). However, it has no absolute frame of reference other than the gravity vector. Using these data, the system can accurately determine motion in three dimensions and rotation in two dimensions. It can only report an increasingly inaccurate estimate of relative position. By contrast, the present invention reports the brush's position and orientation on all three axes. These data are reported relative to the camera but are readily transformed to the coordinate system of the brusher's mouth, when this is detected by the camera system

The present invention delivers more accurate motion tracking than other video based systems. Using the difference between data reported in sequential video capture frames, the motion in its six degrees of freedom can be readily calculated. Other video-based systems can make similar calculations. However the present invention can report motion with greater precision and accuracy by means of intraframe streak analysis. Said analysis is aided by temporal fiducial markers. This precision is critical when assessing the rapid motion of a child's toothbrush.

### BRIEF DESCRIPTION OF THE SEVERAL VIEWS OF THE DRAWING

FIG. 1 A toothbrush (1) is manipulated during a toothbrushing session. A camera (2) records the brush's position, orientation and motion.

FIG. 2 Computational equipment (3) receives toothbrush (1) imagery from the camera (2). It also receives queries (4a) from an outboard process and reports data (4b) in response.

FIG. 3 Three or more fiducial markers (5a,b,c) are attached to the toothbrush (1) in advantageous positions.

FIG. 4 In practice, the toothbrush (1) can assume any position and orientation This figure illustrates a simple rotation of the toothbrush with attached fiducials (5a,b,c) in the figure's image plane.

FIG. 5 This figure represents the position of the fiducials (5a,b,c) as extracted from the image represented in FIG. 4 and located within the camera's frame of reference.

FIG. 6 Using only the fiducial locations (5a,b,c), the system can reconstruct the position of the toothbrush within its frame of reference.

FIG. 7 A light source (7) is positioned near the the lens of the camera (2). It casts an incident ray (8a) on a retroreflective marker (5) which returns a nearly coaxial reflected ray (8b) to said camera.

FIG. 8 An active fiducial (5) emits a light ray (8) directly to the camera (2).

FIG. 9 A large motion (9) of the fiducial (5x,y) within a single exposure period of the camera (2) results in a wide a divergence between initial (8x) and final (8y) light rays.

FIG. 10 The moving fiducial records a streak (10) on the camera's frame of reference, (6).

FIG. 11 An intermittently flashing fiducial produces a streak (10) composed of a series of dots across the camera's frame of reference, (6).

FIG. 12 A large non-linear motion (9) of the fiducial (5x,y) within a single exposure period of the camera (2) results in a wide a divergence between initial (8x) and final (8y) light rays.

FIG. 13 The constantly illuminated fiducial moving on a nonlinear path records a streak (10a) on the camera's frame of reference (6) which is indistinguishable from that in FIG. 10.

FIG. 14 An intermittently illuminated fiducial flashing at a regular rate while moving on a nonlinear path records a streak (10b) with non uniform dot spacing clearly distinguishable from that in FIG. 11.

### DETAILED DESCRIPTION OF THE INVENTION

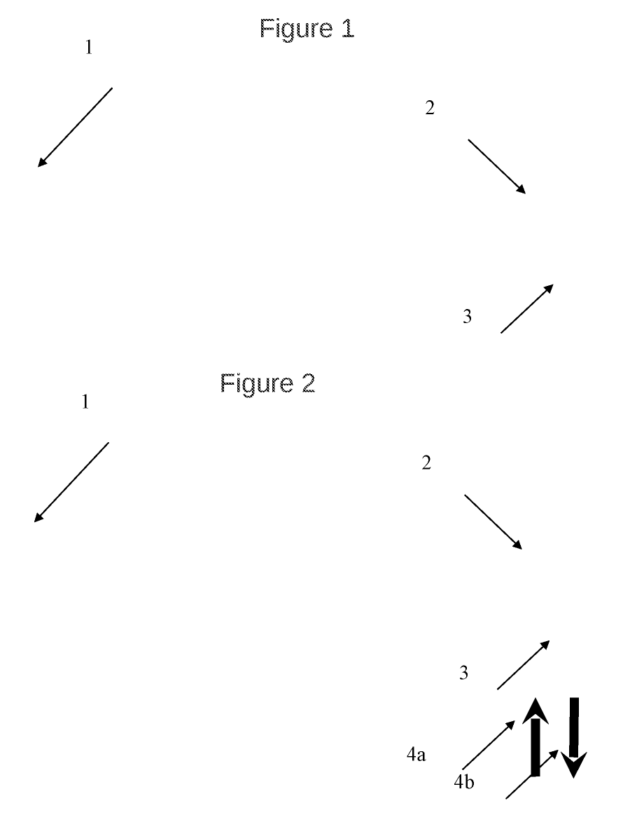

This invention concerns the automated tracking of a moving object. In the present example (FIG. 1), the object is a toothbrush (1) being manipulated during a toothbrushing session by a human subject, the brusher. The camera (2) is used to capture the brush's position, orientation and motion in the three dimensional world. The most useful frame of reference for toothbrush position, orientation and motions is one relative to the brusher's teeth. In the early steps of computation, the immediate frame of reference is that of the sensor. It is subsequently transformed into the coordinate system of the teeth using techniques familiar to those skilled in the art of machine vision.

A tracking system (FIG. 2) consists of the sensor and computational equipment (3) that receives the sensors imagery. It also receives queries (4a) from an outboard process and reports data (4b) in response. These transactions need not be one-to-one, a single query might launch a stream of data, or data streaming might even be the system's power up default state.

At any instant, the tracking system will be able to report realtime data with minimal latency. These data include the x, y and z positions of a reference point on the toothbrush, for instance its center of mass or geometric center. Said data include also the three dimensions of orientation of the object around its center, relative to a canonical ‘neutral’ orientation. In general, the system can calculate these six data, often collectively referred to as the six degrees of freedom, from any single sensor observation.

In addition to the six static degrees of freedom, the system is often called upon to report the object's translational and rotational velocities. These data represent the changes in the static position and orientation data over a fixed period of time. In practical settings, this period is often a camera's frame rate. Typical cameras have a fixed frame rate, often 30 frames per second and this presents a practical limit on precision and accuracy, due to the fast motion of a toothbrush during typical use.

The motion of the brush relative to the sensor's frame rate and exposure time also result in photographic motion-blur. This image degradation taxes any machine vision system, particularly one meant to work in a wide variety of lighting conditions. The features of this invention are meant to address these issues.

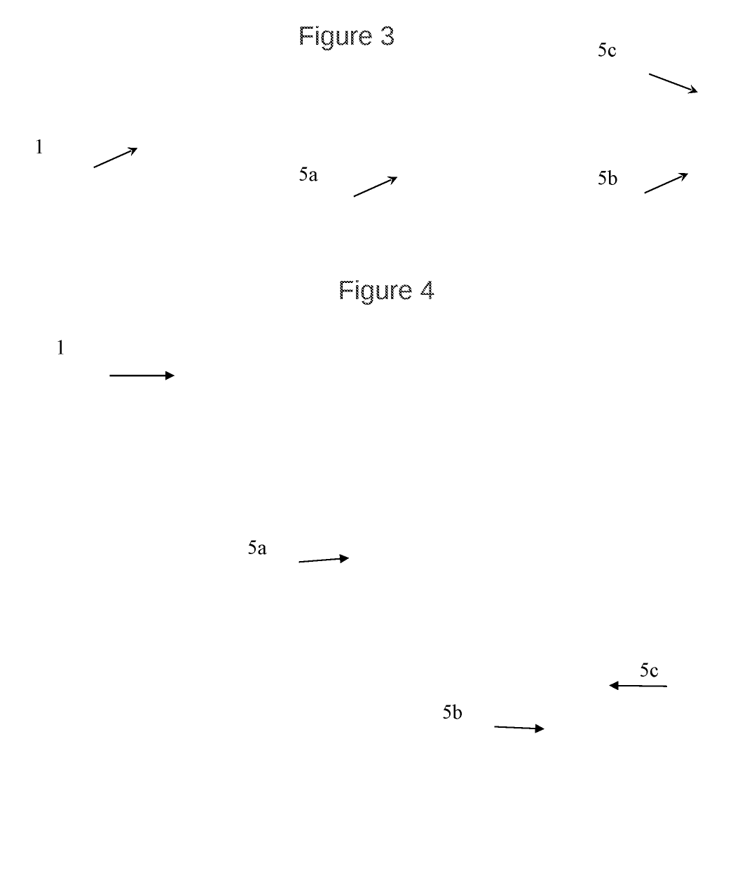

To the tracked object, eg: toothbrush. (FIG. 3), three or more fiducial markers (5a,b,c) are attached in positions that afford the most visibility and least vulnerability to being obscured during use by the brusher's hands or lips. To reduce ambiguity, symmetry is avoided. (An equilateral triangle would be the least useful arrangement.)

A second method of disambiguation is to employ different colors for different fiducials. A third, and inferior method, would be to rely on shapes, numbers or other graphic indicia to distinguish among the fiducials.

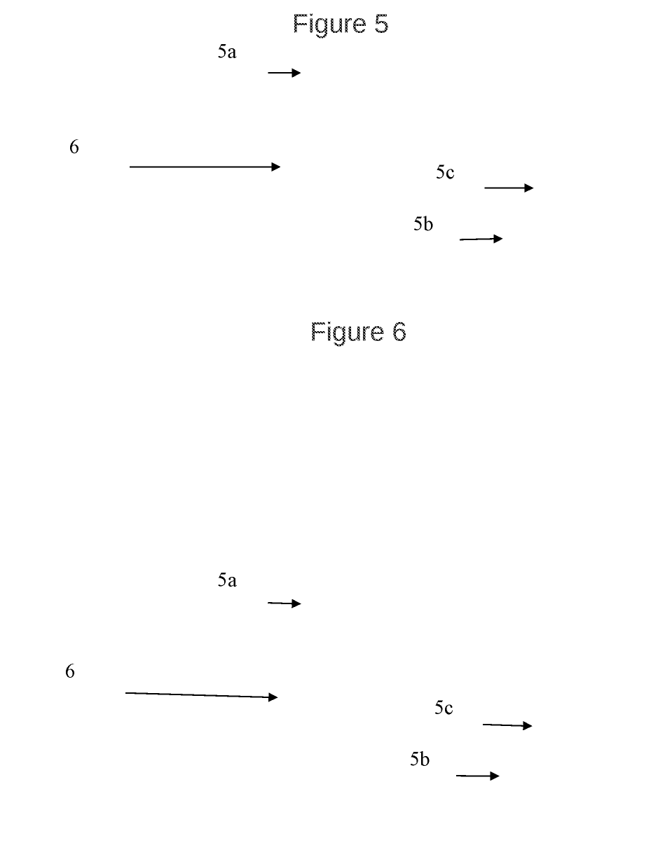

The toothbrush can assume any position and orientation (FIG. 4, simplified to 2D) and by recording only the fiducials themselves (FIG. 5) in the image plane (6), the tracking system can calculate the orientation and position of the brush (FIG. 6) with greater ease and accuracy than by direct observation.

To the extent that these fiducial markers are more salient than the rest of the imagery, the photographic and computational task is simplified. Several means of elevating fiducial salience are discussed,

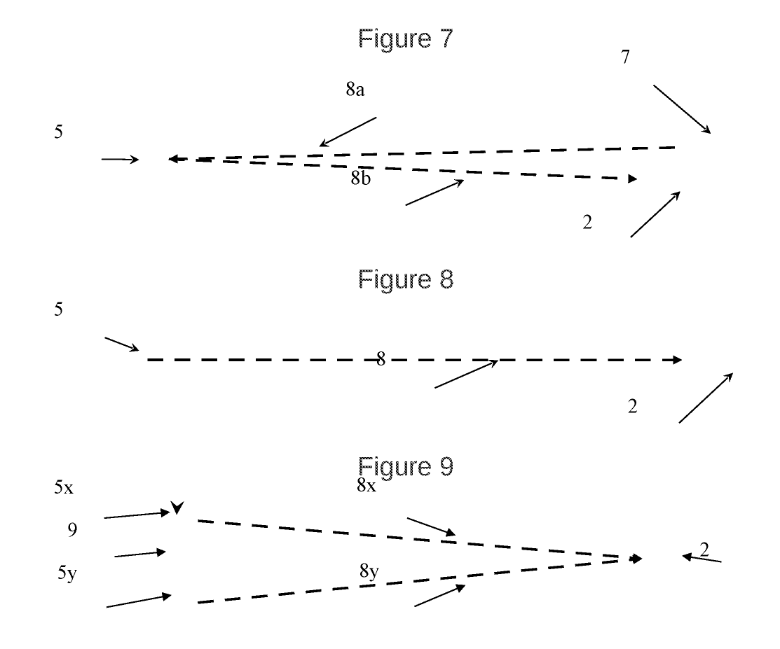

In order to increase the salience of the fiducials, (FIG. 7) retroreflective markers (5) can be employed. A light source (7) positioned close to the sensor aperture (2) will cause an incident ray (8a) to be nearly coaxial with the reflected ray (8b) which is captured by the sensor. Such a slight source can be the selfie portrait light found in some devices, or it can be the display screen of the device. Normal diffuse reflectors will reflect far less light to the sensor. Retroreflective markers will be more salient, particularly when the light (7) is the sole scene illuminator.

A more direct approach to salience (FIG. 8) is seen when each fiducial (5) is itself an active light source.

This can use fluorescent materials, or light-emitting electronic elements. Neither the emitted radiation, nor the reflected radiation considered earlier must be limited to the visible spectrum. Radio waves; microwaves, infrared and ultraviolet are all candidates for fiducial signals, and these may employ RFID or NFC technology. They may utilize technology meant for GPS geolocation. In each case; the system will require a source (sometimes ambient), a sensor and, in some configurations, a set of passive fiducials with high (and possibly selective) albedo in the target wavelength.

Simple emission of visible light is highly practical, as electric lights are a common feature of children's toothbrushes. Often these are flashing lights.

Fiducials that flash at very high rates can improve the tracking process. A toothbrush often exhibits (FIG. 9) a large motion (9) that occurs within the camera's exposure period.

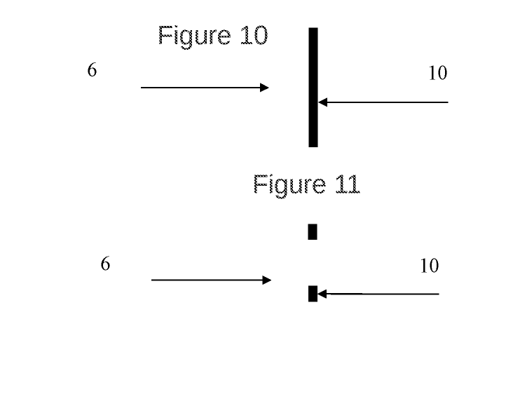

This results in motion blur. Normal photography often captures an image that is too blurred to be usable. This is particularly an acute problem with the diffusely reflective graphic fiducials employed commonly in augmented reality practice. In the case of highly salient fiducials (FIG. 10) however, the motion blur problem is more tractable, because it produces a streak (10).

If the fiducial is an active light source with intermittent flashing, the resulting image (FIG. 11) is a series of dots that is for more conducive to calculation. Non-uniform flashing could even encode the direction of motion—so that direction as well as speed is visible in each frame.

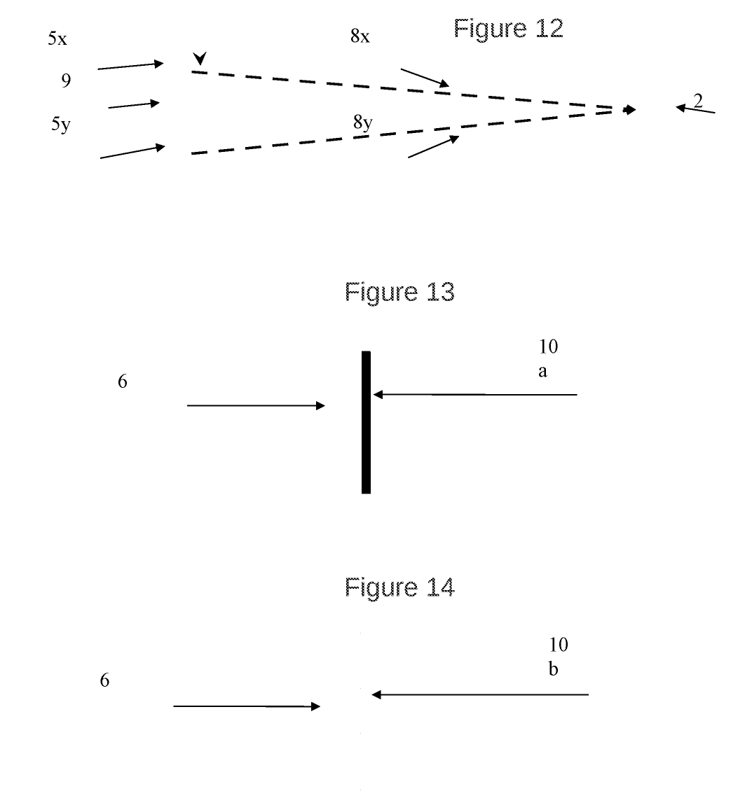

When the velocities within the frame are non-linear (FIG. 12), there are further advantages to the intermittent light source. Rather than a simple streak from a constant light source (FIG. 13), which may be indistinguishable from constant motion (FIG. 11), the resulting image (FIG. 14) shows non uniform dot spacing (10b), from which the intra-frame changes in motion can be calculated with accuracy, precision and reliability.

### EMBODIMENTS

Embodiments of the present invention comprise a set of fiducial markers attached to, painted on, integrated into or otherwise fixed to a toothbrush. Said toothbrush can be manual or powered and can features any arrangement of bristles or other actuators. The invention further comprises a camera, a light source and computational engine. In practice, the light, camera and computer are all components of a smartphone, tablet laptop, fixed computer or similar device. Retroreflective fiducials will require a light source near the camera lens, as would be the case with the devices mentioned, which would sometimes feature a front-facing portrait light and would other times illuminate a portion of the screen to serve as coaxial light. Self-illuminated fiducials emit light directly to the camera. Intermittent fiducial illumination can improve tracking accuracy by enabling intraframe motion analysis.

### EXAMPLES

The following are examples of the invention chosen to illustrate certain features and use cases. The implementation and grouping of features in these examples is purely illustrative and not meant to preclude alternative implementations or groupings.

### Example 1

One embodiment of this invention features a toothbrush with retroreflective markers printed on the body of its handle. These markers might be graphically integrated into a logo or graphic treatment that suggests to the owner only a decorative or branding purpose. Players brush their teeth while interacting with a game on a smartphone or tablet in which the screen and front-facing (selfie) camera are active. Siblings brushing together are independently tracked by the camera, as long as they are within its view. The retroreflective character of the fiducial indicia is activated by light emitted by the game device. If the device has a ‘selfie flash’ (a front-facing photo lamp), this is active. If it does not, a large area of the screen is devoted to coaxial illumination. This takes the form of a wide white border around the image area. Through artful design, the players perceive this border as serving aesthetic rather than functional purpose.

### Example 2

A second embodiment features active fiducial markers in the form of LED lamps. These flash in a frequency that such that each video frame contains five flashes, of which one is brighter and one dimmer than the other three. This flash frequency is to fast to be sensible by humans, but it serves to mark the video frames for ready analysis of motion speed and direction. Patients in a dental practice perform diagnostic brushing assessment using this fiduciated brush and software provided by their dental hygienist running on a popular tablet.

### INDUSTRIAL APPLICABILITY/UTILITY

The present invention is readily operable in a diverse array of embodiments. For example it can serve as the assessment engine in a toothbrush training game, and thus help an unlimited number of children develop healthy dental hygiene habits which will prove valuable over their entire lives.

1. A toothbrush tracking apparatus comprising:
A toothbrush for brushing teeth;
A plurality of least three fiducial markers, said fiducial markers moving in direct relation to movement and/or rotation of the toothbrush;
A sensor capable of detecting the fiducial markers relative to the sensor;
A means for analyzing the sensed locations of three or more fiducials to compute one or more of;
a dimension of position of the toothbrush, or
a dimension of the motion of the position of the toothbrush; or
a dimension of the orientation of the toothbrush, or
a dimension of the change in orientation of the toothbrush

2. A toothbrush tracking apparatus as recited in claim 1, wherein at least one fiducial presents to the sensor greater salience than other objects in the scene.

3. A toothbrush tracking apparatus as recited in claim 2, wherein fiducial salience is elevated by means of electric light emission.

4. A toothbrush tracking apparatus as recited in claim 3, wherein said light is infrared light

5. A toothbrush tracking apparatus as recited in claim 2, wherein fiducial salience is increased as a reaction to an emission of the apparatus, and said apparatus and further comprising:
A means of emission thereby causing the fiducial salience to be increased

6. A toothbrush tracking apparatus as recited in claim 5, wherein fiducial salience is increased by fluorescence, and said means of emitting is light in a wavelength to stimulate fluorescence.

7. A toothbrush tracking apparatus as recited in claim 5, wherein said fiducial salience is achieved by passive RFID markers and said means of emission is a means of activating passive RFID.

8. A toothbrush tracking apparatus as recited in claim 5, wherein fiducial salience is increased by use of retroreflective markers and where said means of emission is a light source located close to the sensor.

9. A toothbrush tracking apparatus as recited in claim 1, wherein the fiducials consist of a plurality of colors and said sensor is capable of distinguishing between the plurality of colors

10. A toothbrush tracking apparatus as recited in claim 1, wherein said sensor captures information in sequential frames, each having a finite period of exposure, during which intraframe motion information is captured from by said sensor. Said means for analyzing sensor location further includes analysis of intraframe motion to improve at least one output.

11. A toothbrush tracking apparatus as recited in claim 10, wherein at least one presents to the sensor greater salience than other objects in the scene.

12. A toothbrush tracking apparatus as recited in claim 11, further comprising a means of modulating the greater salience of one or more fiducial marker to create from each modulated fiducial a set of temporal fiducial markers. for use with the means for analyzing intraframe motion.

13. A toothbrush tracking apparatus as recited in claim 12, wherein said means of modulating the fiducial appearance produces a nonuniform set of temporal markers to reduce the ambiguity of the data presented to the means for analyzing intraframe motion.

14. A toothbrush tracking apparatus as recited in claim 1, further comprising a means for translating at least one output from said means for analyzing sensor data into a coordinate space relative to other objects detected by the sensors

15. An object tracking apparatus comprising:
A plurality of least three fiducial markers, said fiducial markers moving in direct relation to movement and/or rotation of the object;
A sensor capable of detecting the fiducial markers relative to the sensor. Said sensor captures information in sequential frames, each having a finite period of exposure, during which intraframe motion information is captured from by said sensor;
A means for analyzing the sensed locations of three or more fiducials to compute one or more of:
a dimension of position of the object, or
a dimension of the motion of the position of the object, or
a dimension of the orientation of the object, or
a dimension of the change in orientation of the object

16. An object tracking apparatus as recited in claim 15, wherein at least one fiducial presents to the sensor greater salience than other objects in the scene.

17. An object tracking apparatus as recited in claim 16, further comprising a means of modulating the greater salience of one or more fiducial marker to create from each modulated fiducial a set of temporal fiducial markers. for use with the means for analyzing intraframe motion.

18. An object tracking apparatus as recited in claim 17, wherein said means of modulating the fiducial appearance produces a nonuniform set of temporal markers to reduce the ambiguity of the data presented to the means for analyzing intraframe motion.

19. An object tracking apparatus comprising:
A plurality of least three fiducial markers, said fiducial markers moving in direct relation to movement and/or rotation of the object, said fiducial markers fluorescing;
A means of stimulating the fiducials to fluoresce.
A sensor capable of detecting the fiducial markers relative to the sensor;
A means for analyzing the sensed locations of three or more fiducials to compute one or more of:
a dimension of position of the object, or
a dimension of the motion of the position of the object, or
a dimension of the orientation of the object, or
a dimension of the motion of rotation of the object

20. An object tracking apparatus as recited in claim 19, wherein said fiducial markers emit different colors of light in response to their fluorescence
